(19) United States
(12) Patent Application Publication
(10) Pub. No.: US 2020/0237032 A1
(43) Pub. Date: Jul. 30, 2020

(54) APPARATUS FOR MOUNTING ON HAND WITH IDENTIFICATION DEVICE ARRANGED ON THE APPARATUS, AND METHOD FOR MANUFACTURING THE APPARATUS

(71) Applicant: Feig Electronic GmbH, Weilburg (DE)

(72) Inventors: Carsten Berlips, Weilmuenster (DE); Julian Affholderbach, Siegen (DE); Werner Gabel, Dillenburg (DE); Andreas Wennrich, Limburg (DE); Alexandra Baum, Leipzig (DE)

(21) Appl. No.: 16/741,999

(22) Filed: Jan. 14, 2020

(30) Foreign Application Priority Data
Jan. 25, 2019 (EP) 19153694.5

(51) Int. Cl. A41D 1/00; A41D 19/00; A41D 19/04; G06F 3/01

(52) U.S. Cl. CPC A41D 1/005; A41D 19/0024; G06F 3/014; A41D 19/0037; A41D 19/04; A41D 19/0006

(57) ABSTRACT

The invention relates to an apparatus for arrangement on a hand, having an identification device arranged on said apparatus, wherein the apparatus comprises a work glove or a carrying strap which can be arranged on the hand, wherein
a connecting line made of fabric with electrically conductive material is provided between the switch and the identification device,
at least one snap fastener is provided between the identification device and the work glove or carrying strap.
   The invention also relates to a method for producing the apparatus. (FIG. 1).

The invention relates to an apparatus for arrangement on a hand, having an identification device arranged on said apparatus, wherein the apparatus comprises a work glove or a carrying strap, and having an identification device detachably arranged on the work glove or carrying strap. The invention also relates to a method for producing the apparatus.

Prior art (DE 10 2016 109 113 A1) includes an article of clothing, particularly a work garment with a glove comprising an inner side, which is facing the hand when the glove is worn, and an outer side, and in which at least one electric operational element is attached to the glove. Furthermore, an electric contact point is provided for integrating the operational element in a circuit, and at least one cable is provided which electrically connects the operational element with the contact point, wherein the cable is attached to the glove and extends mainly, particularly completely, in at least one neutral region of the glove in a neutral direction of said at least one neutral region with respect to a change in length upon movement of the hand or a finger.

This prior art garment has the disadvantage that it is relatively difficult to produce. Particularly, the lines between the contact point and the operational element must be conducted such that they are all arranged in the neutral region. In addition, a strip of material, particularly a textile strip is provided, wherein the cable and/or the operational element is/are arranged between the strip of material and the glove. The strip of material can be attached to the glove by means of heat bonding. This type of attachment is very rigid and on the other hand not durable.

When operating machinery or initiating reading processes for identifying goods or in operations in which devices are controlled by a remote control unit or the like, gloves or carrying straps on which identification devices or other operational devices are arranged are used in practice. This often requires operation of a mechanical switch.

The gloves or carrying strips are commonly used in logistics, for example to scan goods in shelves before they are picked from the shelf. Hand-held devices which are not attached to a work glove or carrying strap must be picked up for each scan process and put down after the scan process. Arranging the identification device on a work glove or on a carrying strip is an improvement in itself.

It is known from practice that such gloves are only relatively difficult to produce. The electric lines, which are rigid, electric pushbuttons, a circuit board which carries the contact pins for a sensor module, and a fastening element typically made of plastic must be connected to the fabric of the glove, for example by gluing or welding. This requires special know-how, and various technologies must be applied to produce the glove. If the glove is defective and can no longer be used, its parts must be separated again for recycling. By connecting a rigid sensor module to flexible textile and lines arranged therein, high wear and tear due to shearing motion occurs.

The underlying technical problem of the invention is to provide an apparatus for arrangement on a hand having an identification device arranged on said apparatus, particularly a work glove or a carrying strap which can be arranged on a hand, produced in the simplest way possible, has a low manufacturing price, is easily recyclable and furthermore allows easy and reliable handling.

In addition, a method for producing the apparatus is to be provided which is cost-effective and with which a durable apparatus can be created.

This technical problem is solved by an apparatus having the features of claim 1 and by a method having the features of claim 19.

The apparatus according to the invention for arrangement on a hand having an identification device arranged on said apparatus, wherein the apparatus comprises a work glove or a carrying strap which can be arranged on a hand, having an identification device detachably arranged on said work glove or carrying strap, wherein the identification device is arranged on a side of the work glove or carrying strap associated with a back of the hand, is characterized in that
a connecting line made of fabric is provided between the switch and the identification device, wherein an electrically conductive material is arranged in the fabric,
in that a first part of at least one snap fastener is arranged on the identification device, and
in that a second part of the snap fastener configured as counterpart of the first part of the snap fastener is arranged on the work glove or carrying strap in the region of the connecting line made of fabric and the electrically conductive material.

According to another preferred embodiment of the invention, the identification device comprises a switch for operating the identification device and the switch is configured as a switch consisting of at least two layers of fabric in which the electrically conductive material is arranged.

The apparatus according to the invention has the advantage that the connecting line between the switch and the identification device and, if present, the switch are made of fabric, such that the parts required for operating the identification device or the parts required for establishing the electrical connection with the identification device, respectively, can be sewn or stitched onto the work glove or the carrying strap. This avoids another type of fastening, for example welding or heat bonding. The work glove or carrying strap therefore remain very flexible, allowing unrestricted movement of the hand. Sewing has the additional advantage that this type of connection can be established easily and without great technological know-how and that this connection is furthermore very durable. In addition, there is no need for recycling different materials.

In addition, the apparatus according to the invention comprises a snap fastener connection. The identification device comprises a first part of at least one snap fastener and the counterpart of the snap fastener, that is, its second part, is arranged on the work glove or the carrying strap. This allows establishing an electrical connection of the work glove or the carrying strap to the identification device in the simplest manner. To this end, the snap fastener is advantageously arranged on the work glove or the carrying strap in the region of the connecting line consisting of fabric and the electrically conductive material.

The work glove or the carrying strap have the advantage that only such materials are used for their production that can easily be processed in every sewing room without requiring additional technological know-how.

According to a particularly preferred embodiment of the invention, the second part of the snap fastener forms an electrical connection with the connecting line made of fabric and the electrically conductive material arranged in the fabric.

This ensures that an electrically conductive connection is established from the switch via the connecting line made of fabric, wherein an electrically conductive material is arranged in said fabric, via the snap fastener and the electrically conductive connecting line to the identification device. Up to the snap fastener, the switch and the connecting line substantially consist of a fabric in which an electrically conductive material is arranged. This ensures that the electric components of the work glove or the carrying strap are elastic and do not impede the handling of the work glove or the carrying strap as well as the freedom of movement.

In addition, these parts can be arranged by sewing on the work glove or the carrying strap.

According to another embodiment of the invention, the switch is arranged on a finger, particularly index finger, of the work glove or on a loop of the carrying strap which can be attached to a finger, particularly an index finger. In this configuration, the switch is configured to be operated using a thumb. But there is also an option to attach the switch on a loop of another finger (middle, ring finger, little finger). Likewise, the switch can be arranged on the work glove on the middle finger, the ring finger, or the little finger.

To this end, the switch is advantageously arranged on the work glove or the carrying strap in the region of the finger, such that the switch can be operated by a simple sideways movement using the thumb. The switch is particularly advantageously arranged in the region of the second finger joint on the work glove or the carrying strap. The switch is particularly preferably arranged sideways from the finger on the work glove or the carrying strap. The preferred embodiment is the arrangement on the index finger.

According to another advantageous embodiment of the invention, the electrically conductive material is configured as at least one electric line in the fabric of the connecting line. One or more electric conductors may be provided. For example, one or more metal wires or one or more metal filaments, for example, stranded wires can be provided.

According to another advantageous embodiment of the invention, the at least one electric line is arranged in a curved, meandering, or wavy shape or in a zigzag or helical shape in the connecting line formed of the fabric.

The fabric is preferably stretchable. The fabric can be stretchable in at least one direction. Advantageously, the fabric is stretchable in multiple directions. This ensures that the fabric with the at least one integrated electric line can be stretched and does not limit the freedom of movement.

According to another advantageous embodiment of the invention, the work glove or the carrying strap comprises a holder for detachable holding of the identification device and that the holder is made of fabric.

This embodiment has the advantage that the identification device can be arranged in a kind of fabric pocket on the work glove or the carrying strap. The fabric pocket has the advantage that the fabric pocket can also be attached by means of a sewing process to the work glove or the carrying strap.

Providing one or more seams has the advantage that these can easily be produced without requiring special knowledge, that they are durable and lasting, and that the work glove or the carrying strap still remains flexible.

According to another advantageous embodiment of the invention, the holder comprises a tab that can be closed and opened. The identification device is fixed in the holder using this tab. The tab may for example be fixed by means of a velcro fastener or other closing means after it is closed.

The identification device can advantageously be configured as a RFID reader or barcode reader. If the identification device is configured as a barcode reader, the tab advantageously comprises a slot through which the identification device can optically detect or send signals.

In another advantageous embodiment of the invention, the identification device comprises at least one pushbutton for operating and/or adjusting the identification device. The identification device is operated via at least one pushbutton, preferably via two or three pushbuttons. These can be used to make adjustments of the identification device. For example, an operating mode can be set, or the time until switching off, if the device switches off after a longer period of non-use. Another option is that a confirmation request is acknowledged using the pushbuttons.

According to another particularly preferred embodiment of the invention, at least one motion sensor is associated with the identification device.

The identification device detects if it is moved via the motion sensor. If it is not moved for a longer period of time, the identification device switches off automatically. This extends battery life.

In another advantageous embodiment of the invention, a scan process with the identification device can be initiated via a switch or via a hand movement or via at least one pushbutton.

A general option is that the scan process can be initiated by operating the switch. Another option is to perform a hand movement, and the motion sensor will initiate the scan process.

In another advantageous embodiment of the invention, the snap fasteners are configured as standard snap fasteners. This makes the production of the apparatus according to the invention particularly cost-efficient.

The snap fasteners may for example be configured with a toothed ring. In this configuration, they can be pressed into the glove or carrying strap and compressed. This establishes an electrical connection with the connecting line made of fabric, wherein the electrically conductive material is arranged in the fabric. The teeth of the snap fastener come into contact with the electrically conductive material arranged in the fabric, such that an electrically conductive connection is established.

In another advantageous embodiment, a screw is arranged in the first part of the snap fastener, which is arranged on the identification device, and the screw is arranged engaging in a female thread on or in a housing of the identification device. This screw allows a detachable fixed connection of the housing parts to each other. This saves components and makes assembly particularly easy. The screw may have an external hexagon for connecting the screw and the housing part.

In another advantageous embodiment of the invention, the first part of the snap fastener, which is arranged on the identification device, is configured to be in contact with a circuit board arranged in the identification device.

This ensures that an electrical connection exists from the switch via the connecting line made of fabric, wherein the electrically conductive material is arranged in the fabric, and that an electrically conductive connection exists via the snap fastener from the switch to the circuit board. This allows operating the identification device via the switch.

According to another advantageous embodiment of the invention, the identification device comprises at least one replaceable battery. This configuration has the advantage that only the battery must be replaced when it is empty, not the entire identification device. A user can thus work with fewer identification devices.

Advantageously, the identification device is configured as a RFID reader and/or as a RFID read-write device and/or as a barcode reader. The identification device may be equipped with a RFID function. This means that the RFID device detects transponders which may be arranged on or in an article. The detection process is initiated via the switch which is positioned on the apparatus. This makes goods traffic traceable, for example. If for example a person takes a package from a shelf, the identification device with the RFID function is triggered and detects the transponder. The data can be transmitted from the identification device to a central point, for example to a central control device, for example by radio, such that the system detects that a package is taken from the shelf and which package was taken from the shelf.

At the same time, there is an option that the identification device comprises an electronics circuit with a barcode reader. This device can be used to detect a package of articles by reading out a barcode. The data can once again be transmitted to a central control device, for example by radio.

There is also an option to first store the data in the identification device and to transmit it only when the identification device is connected, for example to a computer.

According to a particularly preferred embodiment, the identification device comprises an apparatus for communication by radio. This also makes it possible to transmit data recorded by the identification device directly by radio to a central recording and control point.

The method according to the invention for producing the apparatus according to claim 1 is characterized in that the switch and/or the connecting line and/or the holder of the identification device is connected to the work glove or the carrying strap by sewing or stitching.

The work glove and/or the carrying strap is particularly easy to produce due to the production, particularly of the electrically conductive components, but alternatively and in addition of the holder for the identification device. Sewing does not require special technical skills. In addition, the seams are durable and can be made flexible.

According to a particularly advantageous embodiment of the method according to the invention, the work glove or carrying strap which can be arranged on the hand is exclusively or mainly produced by sewing. The entire glove or carrying strap can in principle be produced by sewing. But it is also possible to produce individual parts of the glove or carrying strap by means of other joints. According to the invention, however, the glove or carrying strap is to be predominantly produced by sewing.

According to another advantageous embodiment of the invention, the snap fasteners are pressed into the work glove or into the carrying strap.

The work glove or carrying strap according to the invention is advantageously configured with conventional snap fasteners with a toothed ring, which can easily be electrically connected to the electrically conductive material arranged in the fabric using the connecting line made of fabric. If the snap fasteners have a toothed ring at their bases, the teeth can be pressed into or through the textile material. Then the teeth are crimped, such that the teeth hold the snap fastener in or on the textile material. This produces a simple connection with the existing connecting line and the electrically conductive material, which is arranged in the fabric.

A fabric based electric pushbutton is advantageously located on the work glove or carrying strap; it can also be simply sewn in and once again easily connected by sewing to the connecting line made of fabric, in which an electrically conductive material is arranged.

The identification device can be mechanically fastened to the work glove or carrying strap in a simple manner to establish an electrically conductive connection, namely by means of the snap fasteners. The snap fasteners may advantageously be arranged recessed into the device, such that they comprise an extra guide in addition to the actual snap fastener.

Another advantage is that the overall height of the apparatus can be reduced as well in this manner.

The identification device is advantageously arranged in a fabric pocket which is sewn onto the work glove or the carrying strap. This fabric pocket has various functions. On the one hand, the fabric pocket prevents the device from slipping, on the other hand, the fabric pocket protects the device as well as the materials to be processed. Furthermore, the fabric pocket ensures that the identification device can simply be removed from the holder in the form of the fabric pocket.

According to a particularly preferred embodiment of the invention, the work glove or the carrying strap exclusively consists of materials which can easily be processed in any tailor shop.

The identification device carries the counterparts of the snap fasteners of the work glove or the carrying strap. The snap fasteners may be configured as conventional snap fasteners, which are fastened to the device. Another option is to use specially made snap fasteners, which may for example be provided with a screw for screw connecting the housing parts using the screws inside the snap fasteners.

The snap fasteners which are arranged on the identification device are primarily used for the electrical connection inside the device.

As explained above, the identification device advantageously consists of an electronic circuit with a barcode reading unit or is configured as a RFID reader or RFID read-write device. The RFID reader is advantageously operated using the fabric pushbutton of the work glove or the carrying strap. The identification device can in principle also be operated via pushbuttons on the device.

According to an advantageous embodiment of the invention, the device includes at least one acceleration sensor which switches the device automatically off if the device has not been moved for a longer period of time. The acceleration sensor can also be used for evaluating movements and special functions derived therefrom, such as switching on the device.

The identification device advantageously has a radio function for communication with at least one other device, for example a control and reading device or a computer, to be able to read out data from the identification device or to load updates into the identification device. Alternatively or in addition, the identification device can be connected to another device, for example a control and reading device or a computer, via a wired connection.

The identification device advantageously comprises LEDs of different colors and brightness for signaling alarms and states. Other feedback to a user may be by haptic and/or acoustic means. Advantageously, the identification device is powered by a battery, which a user can easily replace with one hand and without any tools.

The holder on the work glove or the carrying strap may be configured such that the battery can be replaced when the identification device is located in the holder of the work glove or carrying strap.

Another option is to wear the carrying strap over a glove, for example a work glove or just a hand-warming glove. This is particularly possible because the carrying strap is advantageously adjustable in size.

Other features and advantages of the invention can be derived based on the associated drawings, which show exemplary embodiments of an apparatus according to the invention, without limiting the invention to these exemplary embodiments. Wherein:

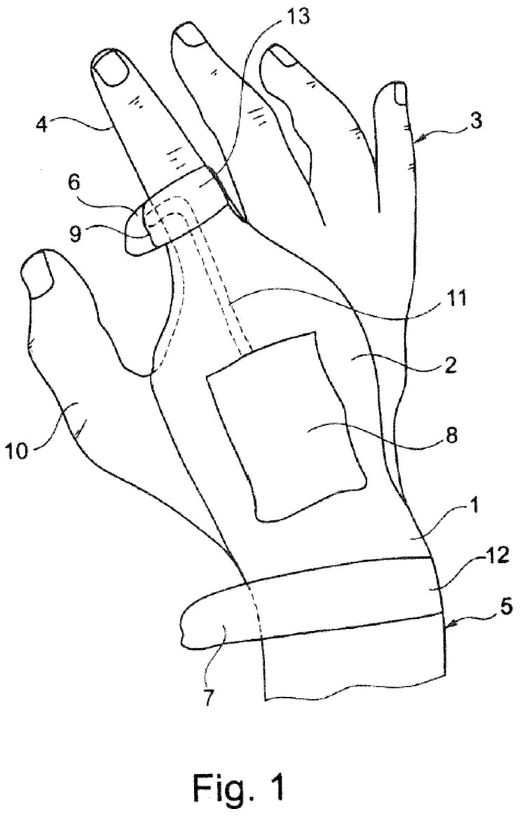

FIG. 1 shows a hand with a carrying strap in a view towards the back of the hand;

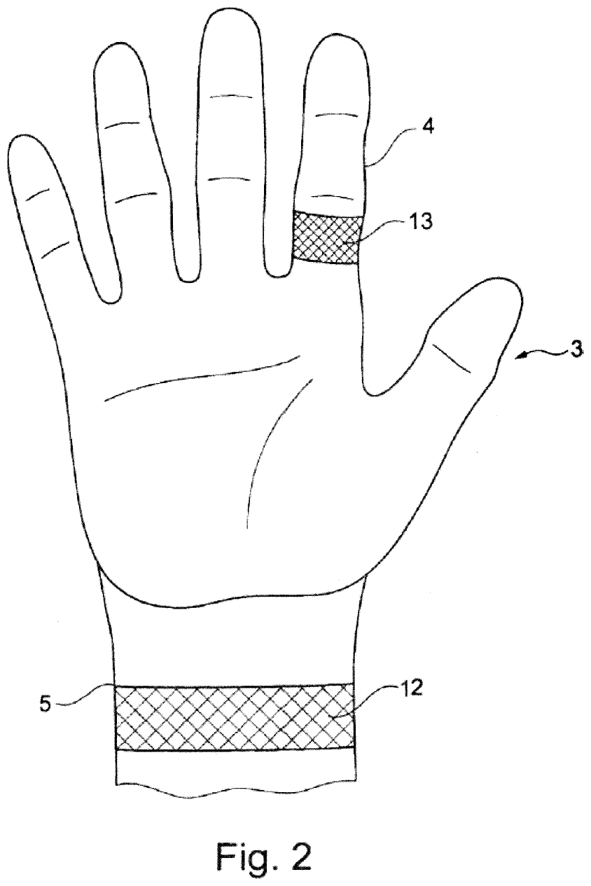

FIG. 2 shows a hand with a carrying strap in a view towards the palm;

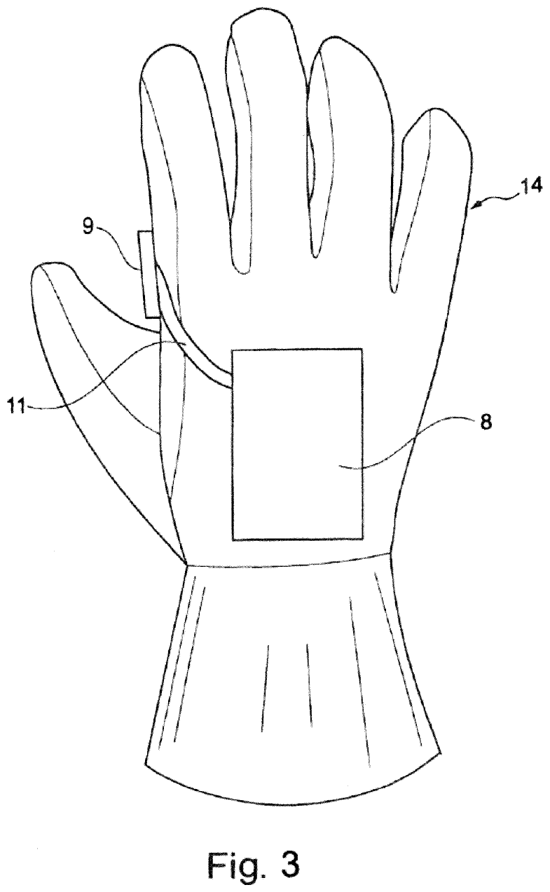

FIG. 3 shows a top view of a work glove;

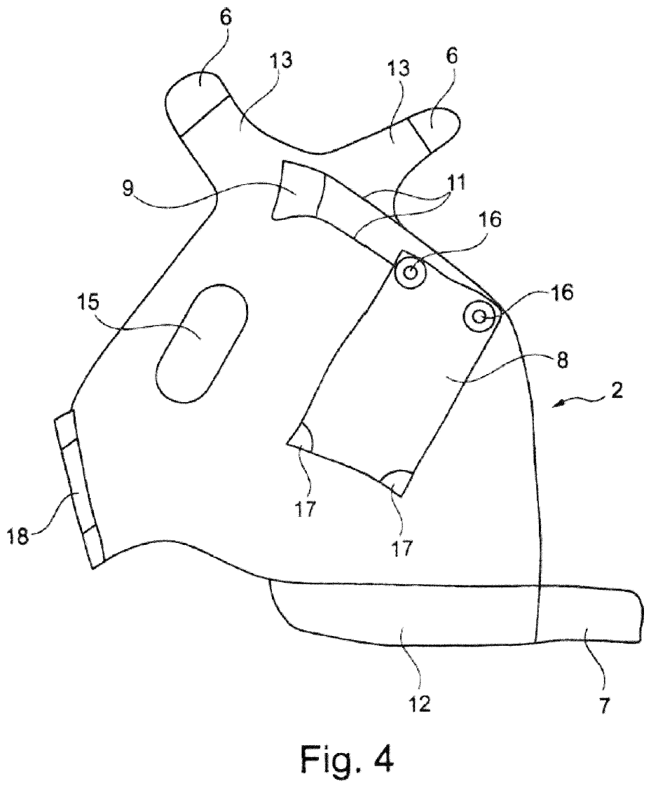

FIG. 4 shows a top view of a carrying strap according to the invention;

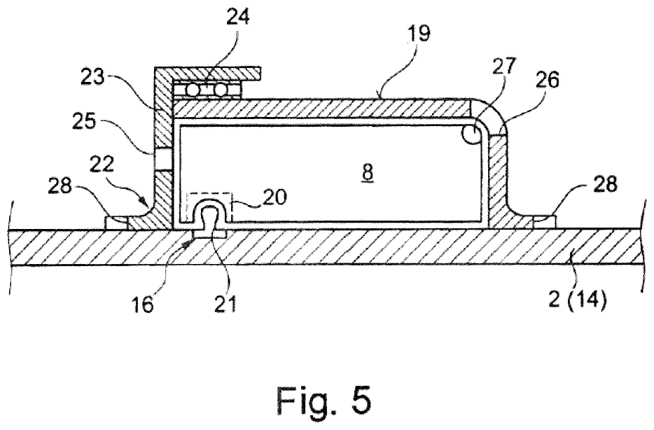

FIG. 5 shows a cross section of a holder for the identification device;

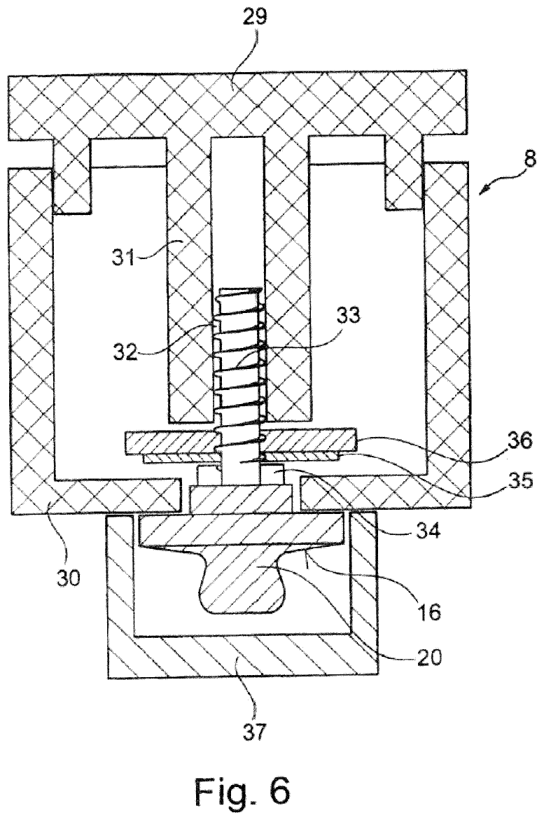

FIG. 6 shows a cross-section through an identification device with a snap fastener;

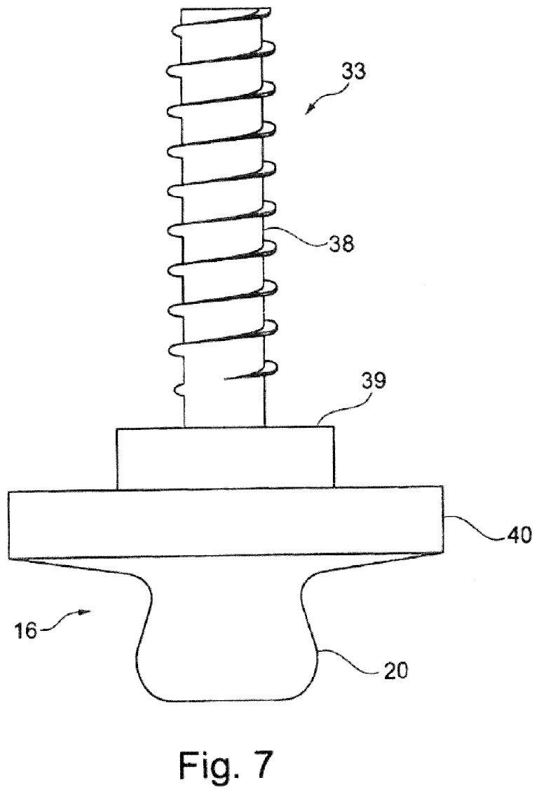

FIG. 7 shows a side view of a part of the snap fastener according to FIG. 6;

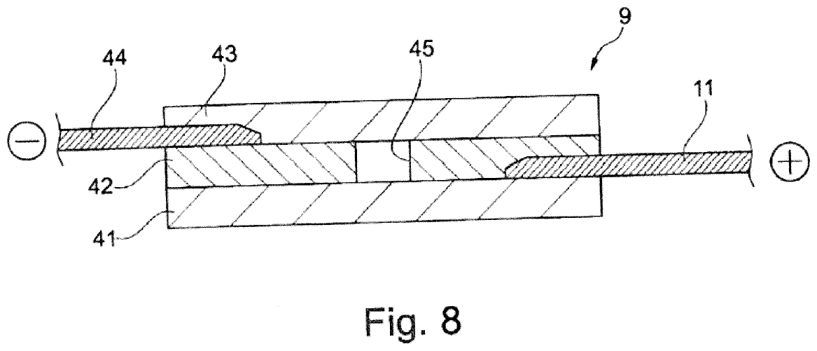

FIG. 8 shows a cross section of a fabric switch to the snap fasteners;

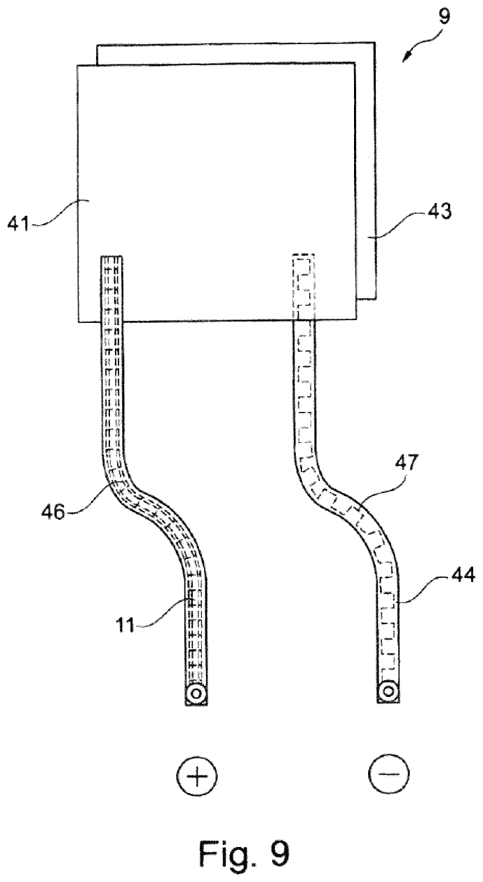

FIG. 9 shows a top view of the connection from the fabric switch to the snap fasteners;

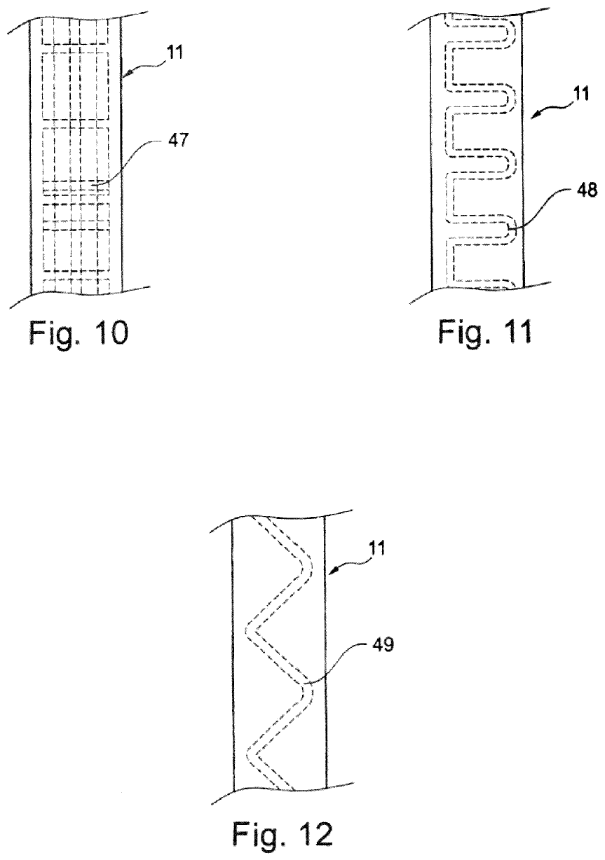

FIG. 10 shows a top view of a connecting line with an electrically conductive stranded wire;

FIG. 11 shows a top view of a connecting line with a meander-shaped electric line;

FIG. 12 shows a top view of a connecting line with a zigzag-shaped electric line;

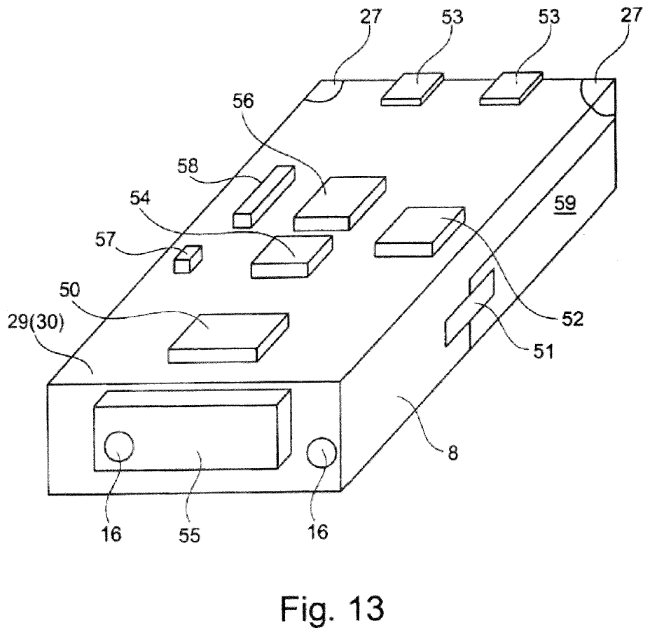

FIG. 13 shows a perspective view of an identification device.

FIG. 1 shows an apparatus 1 which is configured as a carrying strap 2 and arranged on a hand 3 of a wearer. The carrying strap 2 is detachably attached to the hand 3 in the region of the index finger 4. Likewise, the carrying strap 2 is attached in a region of a forearm or wrist 5. The carrying strap 2 has fasteners 6, 7, which are configured as velcro fasteners. An identification device 8 which may for example be configured as a RFID reader or barcode reader is arranged on the carrying strap 2.

The identification device 8 can be used to electronically detect goods (not shown), which may for example be arranged in a shelf. For example, there is an option that the goods have transponders which can be detected by the identification device 8 configured as a RFID reader or barcode reader. To start the scan process, a switch 9 is arranged on the carrying strap 2 in the region of the index finger 4. The switch 9 is arranged on the carrying strap 2 in the region of the index finger 4 in such a manner that it can easily be operated by pressing using a thumb 10. An electrical connecting line 11 extends from the switch 9 to the identification device 8. The carrying strap 2 is mainly formed of fabric. Only the fasteners 6, 7 are configured as velcro fasteners consisting of a loop tape and an opposite hook tape. The connecting line 11 is also formed of fabric, and electrically conductive materials are arranged inside the fabric.

The identification device 8 is also arranged in a fabric pocket, which will be described in more detail below.

The apparatus 1 will be arranged with the identification device on the hand 3 for performing the scan processes. The transponders or barcodes can be detected using the identification device 8.

The identification device 8 can be removed from the carrying strap 2 by taking it out of the holder described in more detail in FIG. 5. The carrying strap 2 can then be washed or cleaned. The carrying strap 2 furthermore has the advantage that all its parts, such as the switch 9, which is configured as a fabric switch, the connecting line 11, which is also formed of fabric, and the holder for the identification device 8, which is also made of fabric, are completely formed of fabric and that all connections can be made by one or more sewing processes.

The carrying strap 2 is arranged on the wrist or forearm 5 by means of a loop 12 closed with the fastener 7, which is adjustable in size, that is, can be adapted to the wearer. In addition, the carrying strap is attached with a loop 13 to the index finger. This loop 13 can also be adjusted in size and adapted to the wearer by means of the fastener 6.

According to FIG. 2, the hand 3 is shown in a view towards the palm. The loops 12, 13 of the carrying strap 2 enclose the forearm or the wrist 5 as well as the index finger 4.

FIG. 3 shows a modified exemplary embodiment with a work glove 14. On the work glove 14, the identification device 8 is preferably arranged in a fabric pocket (not shown in FIG. 3). The work glove 8 also comprises the switch 9, which advantageously is configured as a fabric switch, and the connecting line 11, which also consists of fabric, with an electrically conductive material integrated into the fabric.

FIG. 4 shows the carrying strap 2 with the loop 12 and the fastener 7, which can be arranged in the region of the wrist/forearm 5. Furthermore, the loop 13 with the fastener 6 is shown. The loop 13 encloses the index finger, as shown in FIG. 1.

In the embodiment shown in FIG. 4, an opening 15 for the thumb 10 (not shown in FIG. 4) is provided. The seat of the carrying strap 2 on the hand 3 is better and firmer in the embodiment according to FIG. 4.

The identification device 8 is arranged on the carrying strap 2, slid into a fabric pocket which is described in FIG. 5. Flexible textile electrical connecting lines 11 extend from the identification device 8 to the switch 9, which is also configured as a fabric switch or fabric pushbutton. The connecting lines 11 lead to the snap fasteners 16 and are electrically connected to them. First parts of the snap fasteners 16 are on the one hand arranged on the carrying strap 2. The counterparts, that is, the second parts of the snap fasteners 16, are arranged in the identification device 8. By bringing together the snap fasteners 16, electrical contact with the switch 9 is established between the identification device 8 and the electrically conductive connecting lines 11. Recesses 17 are provided in the fabric pocket yet to be described in detail, for example for LEDs or pushbuttons of the identification device 8.

The carrying strap 2 further comprises a tab 18.

FIG. 5 shows the carrying strap 2 or the work glove 14. A fabric pocket 19 is arranged on the carrying strap 2 or work glove 14. The identification device 8 is arranged in the fabric pocket 19. The identification device 8 has a first (female) part 20 of a snap fastener 16. A second (male) part 21 of the snap fastener 16 is provided in the carrying strap 2 or the work glove 14, which forms the counterpart to the first (female) part 20. The two parts 20, 21 of the snap fastener 16 are brought into contact, such that the identification device 8 is fixed, on the one hand, via the snap fastener 16 and on the other hand in the fabric pocket 19 on the carrying strap or work glove. The fabric pocket 19 encloses the identification device 8 but for a front side 22. In this region, a tab 23 is provided which can also be closed with a fastener, which may for example be configured as a velcro fastener 24. A slot 25 is provided in the tab 23. If the identification device 8 is configured as a barcode reader, a barcode can be scanned through the slot 25.

The fabric pocket 19 further comprises an opening 26. The opening 26 corresponds to a LED 27 of the identification device 8, such that the LED 27 can be seen from outside. Alternatively, a switch (not shown) can be arranged on the identification device 8 in the region of the opening 26.

The fabric pocket 19 as well as the tab 23 are attached to the carrying strap 2 or work glove 14 by means of seams 28.

The second part 21 (male part) of the snap fastener 16 can be pressed into the carrying strap 2 or work glove 14. Snap fasteners 16 having a toothed ring can be used, which can easily be connected to the electrically conductive material (not shown in FIG. 5) in the connecting line 11.

As can be seen in FIG. 5, the first part 20 (female part) of the snap fastener 16 is recessed into the identification device 8. This reduces the overall height of the identification device. Furthermore, an additional guide is provided for the second part 21 (male part) of the snap fastener 16.

According to FIG. 6, the identification device 8 is shown, which comprises an upper housing shell 29 and a lower housing shell 30. The upper housing shell 29 comprises a pin 30 with a female thread 31. A screw 33, which passes through the first part 20 of the snap fastener 16, engages in the female thread 31. Furthermore, a spring washer 34 as well as a contact surface 35 of a circuit board 36 are provided. On the one hand, this allows to establish an electrically conductive connection to the circuit board 36 via the first part 20 of the snap fastener 16. On the other hand, the screw 33 engages in the female thread 32 of the pin 31 of the upper housing shell 29, such that the upper housing shell 29 and the lower housing shell 30 of the identification device 8 are detachably connected to each other. The screw 33 can be operated by means of a tool, for example a socket wrench 37.

FIG. 7 shows the screw 33 with a thread 38. The screw 33 also comprises a contact surface 39 to establish electrical contact with the contact surface 35 of the circuit board 36. Furthermore, a tool application point 40 is provided to operate the screw 33 with a tool 37. Furthermore, a first part of the snap fastener 16 is arranged at the screw 33.

As can be derived from FIGS. 5, 6, and 7, the first and second parts 20, 21 (female and male part) of the snap fastener 16 can be arranged at any desired place on the identification device 8 and the work glove 14 or carrying strap 2.

FIG. 8 shows the switch 9, which consists of multiple layers 41 to 43. Layer 41 represents a first textile electrode with a sewn on connecting line 11. Layer 43 represents a second textile electrode with a sewn on connecting line 44. Layer 42 is a buffer layer comprising a cutout 45. If pressure is applied to the textile switch 9, the layers 41, 43 come into contact, and an electrical connection is established.

FIG. 9 once again shows the switch 9 with the sewn on connecting lines 11 and 44 and the electrodes 41 and 43. The intermediate layer 42 is no longer shown in FIG. 9. The connecting lines 11, 44 are shown as examples with the electrical lines arranged in the connecting lines 11, 44, which are made of fabric. The electrical line 46 is arranged in a meandering shape in the connecting line 11. In the connecting line 44, the electrical line is configured as a mesh consisting of stranded wires.

Other examples of the arrangement of electric lines in the connecting lines 11 are shown in FIGS. 10 to 12.

FIG. 10 once again shows the arrangement as a mesh 47 with stranded wires.

In FIG. 11, an electrical line 48 is arranged in a meandering shape in the connecting line 11.

In FIG. 12, an electrical line 49 is arranged in a zigzag shape in the connecting line 11.

FIG. 13 shows the identification device 8, which comprises a battery 59. The battery 59 is part of the housing 29, 30, which is configured as a two-piece housing (not shown in FIG. 13). The battery 59 can be disconnected from the identification device 8 by means of a release button 51. The identification device 8 forms a mechanical and electrical interface to the outside via the snap fasteners 16. Radio communication with the outside is performed by an integrated radio module 52. The identification device 8 can be adjusted and operated via buttons 53 and an acceleration sensor 54, or via external interfaces, respectively. The barcode unit 55 or a RFID unit 56 can be used to read barcodes or scan RFID transponders. The identification device 8 can also be adjusted via the barcode unit 55 or the RFID unit 56. A user can receive feedback messages in acoustic form via a speaker 57, optically via the LEDs 27, or haptically via a vibration unit 58. The identification device may comprise other electronic components, wherein just one component 50 is shown.

The identification device 8 is fully functional without the carrying strap 2. It can be activated via buttons 53 or the acceleration sensor 54. In this case, the snap fasteners 16 are used for mechanical fastening. But they can also be used for charging the identification device 8, for example. The advantage of the snap fasteners 16 is that they are intended for fabric and can easily fastened to fabric.

The identification device 8 consists of a combination of barcode and RFID scanning means, which may also be operated separately.

The components 50, 52, 54, 55, 56, 57, 58 are just shown schematically. These components are arranged inside the identification device 8.

### REFERENCE NUMERALS

1 apparatus
2 carrying strap
3 hand
4 index finger
5 forearm/wrist
6 fastener
7 fastener
8 identification device
9 fabric switch
10 thumb
11 connecting line
12 loop
13 loop
14 work glove
15 opening
16 snap fasteners
17 recess
18 tab
19 fabric pocket
20 first part of snap fastener 16
21 second part of snap fastener 16
22 front of pocket 19
23 tab
24 fastener
25 slot
26 opening
27 LED
28 seams
29 upper housing shell
30 lower housing shell
31 pin
32 female thread
33 screw
34 spring washer
35 circuit board contact surface
36 circuit board
37 tool
38 thread
39 contact surface
40 tool application point
41 position of fabric switch 9
42 position of fabric switch 9
43 position of fabric switch 9
44 connecting line
45 cutout
46 electrical line
47 electrical line
48 electrical line
49 electrical line
50 electronic component
51 release button
52 integrated radio module
53 buttons
54 acceleration sensor
55 barcode unit
56 RFID unit
57 speaker
58 vibration unit
59 battery

1. An apparatus (1) for arrangement on a hand (3) having an identification device (8) arranged on said apparatus (1), wherein the apparatus (1) comprises a work glove (14) or a carrying strap (2) which can be arranged on a hand (3), having an identification device (8) detachably arranged on said work glove (14) or carrying strap (2), wherein the identification device (8) is arranged on a side of the work glove (14) or carrying strap (2) associated with a back of the hand,
characterized in that
a connecting line (11, 44) made of fabric is provided between the switch (9) and the identification device (8), wherein an electrically conductive material (46, 47, 48, 49) is arranged in the fabric,
in that a first part (20) of at least one snap fastener (16) is arranged on the identification device (8), and in that a second part (21) of the snap fastener (16) configured as counterpart of the first part (20) of the snap fastener (16) is arranged on the work glove (14) or carrying strap (2) in the region of the connecting line (11, 44) made of fabric and the electrically conductive material.

2. The apparatus according to claim 1, characterized in that the identification device comprises a switch (9) for operating the identification device (8) and the switch (9) is configured as a switch (9) consisting of at least two layers of fabric (41, 42, 43) in which the electrically conductive material is arranged.

3. The apparatus according to claim 1, characterized in that the second part (21) of the snap fastener (16) forms an electrical connection with the connecting line (11, 44) made of fabric and the electrically conductive material (46, 47, 48, 49) arranged in the fabric.

4. The apparatus according to claim 1, characterized in that the switch (9) is arranged on a finger, particularly index finger, of the work glove (14) or on a loop (13) of the carrying strap (2) which can be attached to a finger, particularly an index finger.

5. The apparatus according to claim 1, characterized in that the electrically conductive material in the fabric of the connecting line (11, 44) is configured as at least one electrical line (46, 47, 48, 49).

6. The apparatus according to claim 5, characterized in that the at least one electrical line (46, 47, 48, 49) is arranged in a curved shape or meandering shape or wavy shape or zigzag shape or helical shape in the connecting line (11, 44) formed of fabric.

7. The apparatus according to claim 1, characterized in that the work glove (14) or the carrying strap (2) comprises a holder (19) for detachable holding of the identification device (8) and in that the holder (19) is made of fabric.

8. The apparatus according to claim 7, characterized in that the holder (19) comprises a tab (18) which can be closed and opened.

9. The apparatus according to claim 8, characterized in that the tab (18) comprises a slot (25).

10. The apparatus according to claim 1, characterized in that the identification device (8) comprises at least one pushbutton for operating and/or adjusting the identification device (8).

11. The apparatus according to claim 1, characterized in that at least one motion sensor is arranged in the identification device (8).

12. The apparatus according to claim 1, characterized in that a scan process with the identification device (8) can be initiated via a switch (9) and/or via a hand movement or via at least one pushbutton (53).

13. The apparatus according to claim 1, characterized in that the snap fasteners (16) are configured as standard snap fasteners.

14. The apparatus according to claim 1, characterized in that a screw (33) is arranged in the first part (20) of the snap fastener (16), which is arranged on the identification device (8), and in that the screw (33) is arranged engaging in a female thread (32) on or in a housing (29) of the identification device (8).

15. The apparatus according to claim 1, characterized in that the first part (20) of the snap fastener (16), which is arranged on the identification device (8), is configured to be in contact with a circuit board (36) arranged in the identification device.

16. The apparatus according to claim 1, characterized in that the identification device (8) comprises at least one replaceable battery (59).

17. The apparatus according to claim 1, characterized in that the identification device (8) is configured as a RFID reader and/or a RFID read-write device and/or a barcode reader.

18. The apparatus according to claim 1, characterized in that the identification device (8) comprises an apparatus for communication by radio.

19. A method for producing the apparatus (1) for arrangement on a hand (3) having an identification device (8) arranged on said apparatus (1), wherein the apparatus (1) comprises a work glove (14) or a carrying strap (2) which can be arranged on a hand (3), having an identification device (8) detachably arranged on said work glove (14) or carrying strap (2), wherein the identification device (8) is arranged on a side of the work glove (14) or carrying strap (2) associated with a back of the hand, and
wherein a connecting line (11, 44) made of fabric is provided between a switch (9) and the identification device (8), wherein an electrically conductive material (46, 47, 48, 49) is arranged in the fabric,
a first part (20) of at least one snap fastener (16) is arranged on the identification device (8), and in that a second part (21) of the snap fastener (16) configured as counterpart of the first part (20) of the snap fastener (16) is arranged on the work glove (14) or carrying strap (2) in the region of the connecting line (11, 44) made of the fabric and the electrically conductive material, characterized in that the switch (9) and/or the connecting line (11, 44) and/or the holder (19) of the identification device (8) is connected to the work glove (14) or the carrying strap by sewing or stitching.

20. The method according to claim 19, characterized in that the work glove (14) or the carrying strap (2) which can be arranged on the hand (3) is exclusively or mainly produced by sewing.

21. The method according to claim 19, characterized in that the snap fasteners (16) are pressed into the work glove (14) or the carrying strap (2).
